(19) United States
(12) Patent Application Publication
(10) Pub. No.: US 2012/0110911 A1
(43) Pub. Date: May 10, 2012

(54) Motor mount assembly

(76) Inventors: Liu Heng, Taiwan (CN); Yi Cheng Hsiung, Taipei Hsien (CN); Te San Liu, Taipei City (TW)

(21) Appl. No.: 13/291,599

(22) Filed: Nov. 8, 2011

Related U.S. Application Data
(60) Provisional application No. 61/411,286, filed on Nov. 8, 2010.

(51) Int. Cl. E05F 15/02; F16M 13/00

(52) U.S. Cl. 49/358; 248/674

(57) ABSTRACT

A door operating system for open and closing a door. The door operating system including a control unit for providing a signal indicative of whether the door is to be moved to an open or closed position. A motor mounting assembly is coupled to the control unit. The motor mounting assembly includes a motor operatively coupled to the control unit. The motor mount assembly further includes a primary chassis having a drive gear assembly coupled to the door and the motor and a secondary chassis isolated from vibrations with the primary chassis, the secondary chassis configured to mount to the motor assembly.

### CROSS-REFERENCE TO RELATED APPLICATIONS

This application claims priority to U.S. Patent Application Ser. No. 61/411,286 filed Nov. 8, 2010, which is incorporated herein by reference in its entirety.

### FIELD OF THE INVENTION

The invention relates to an assembly for mounting a motor, and more specifically, to an assembly for mounting a motor for use with a system for moving a movable barrier.

### BACKGROUND OF THE INVENTION

Various types of movable barrier operators, such as automatic garage door openers, have existed for many years. Conventional movable barrier operators are typically electromechanical devices which raise and lower a door (such as a garage door) to unblock and block a door opening in response to actuating signals. The signals are electrical signals transmitted by closure of a push-button switch through electrical wires or by radio frequency from a battery-operated, remote controlled actuating unit. In either case the electrical signals initiate movement of the door from the opposite condition in which it resides. That is, if the garage door is open, the actuating signal closes it. Alternatively, when the garage door is closed, the actuating signal will open the garage door. Once movement has been initiated, the system is typically deactuated when the garage door movement trips a limit switch as the garage door approaches its open or closed position.

A noted drawback associated with conventional movable barrier operators is that since the motor mount assembly typically includes an alternating current (AC) motor mounted directly to the chassis (as shown in FIGS. 1A-1C) wherein the output torque of the motor in transferred to a worm gear fixed on the motor shaft, then to a driven gear connected to the final output shaft which is directly connected to the driving gear or wheel driving the barrier. Typically the worm gear and the driven gear together form a speed reduction mechanism. A noted drawback of this configuration is that every moving piece inside the operator is directly connected to the chassis causing vibration and noise generated from the running motor to be directly transferred to the entire movable barrier system thus causing significant unwanted noise and vibration to be translated to the mounting surface (e.g., a building/house) when operated.

### SUMMARY OF THE INVENTION

In one aspect of the invention according to the illustrated embodiments is the provision of a motor mount assembly that combines the gear assembly into a gear box wherein the gear box and motor are together mounted to form one single component hereinafter termed the “motor assembly”. This motor assembly preferably includes a separate chassis (e.g., a sub-chassis), which is allowed to suspend and vibrate separately from the other components of the movable barrier opener assembly. Preferably, vibration is absorbed by rubber dampers (or like elements) installed between the chassis of the movable barrier opener assembly and that of the aforesaid motor assembly. Preferably, a final output shaft is turned from one single piece into two, connected together with preferably a rubber coupler, so that torque generated from the motor is transferred to the driving sprocket even as the motor assembly is vibrating.

### BRIEF DESCRIPTION OF THE DRAWINGS

The objects and features of the invention can be understood with reference to the following detailed description of an illustrative embodiment of the present invention taken together in conjunction with the accompanying drawings in which:

FIGS. 1A-1C illustrate a prior art movable barrier opening system;

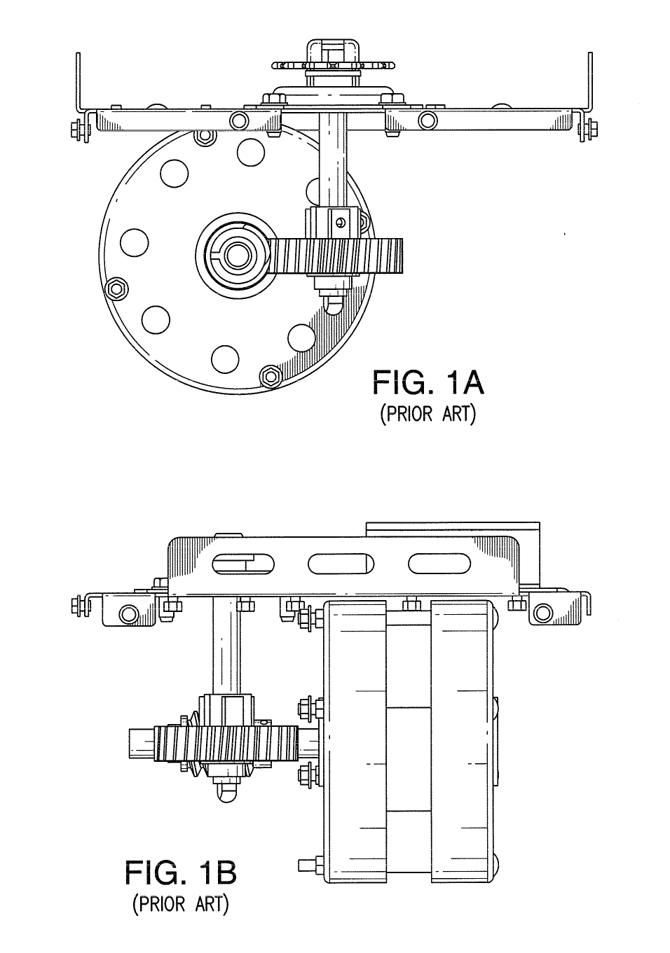

FIG. 2 illustrates a front planar view of the movable barrier opening system of the present invention in accordance with an illustrated embodiment;

FIG. 3 illustrates a left planar view of the movable barrier opening system of FIG. 2; and

FIG. 4 illustrates a right planar view of the movable barrier opening system of FIG. 2.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

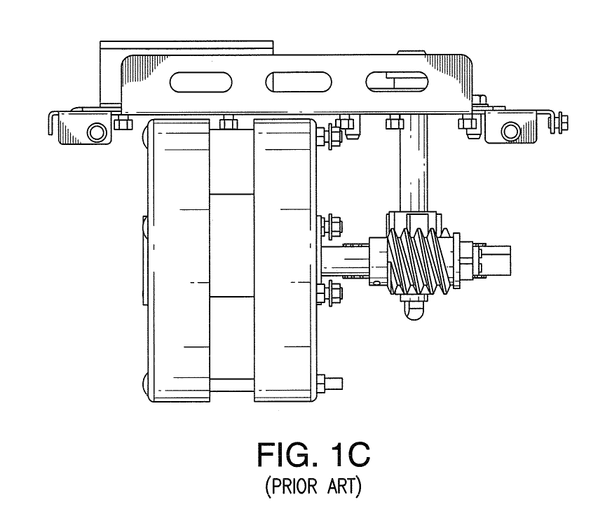

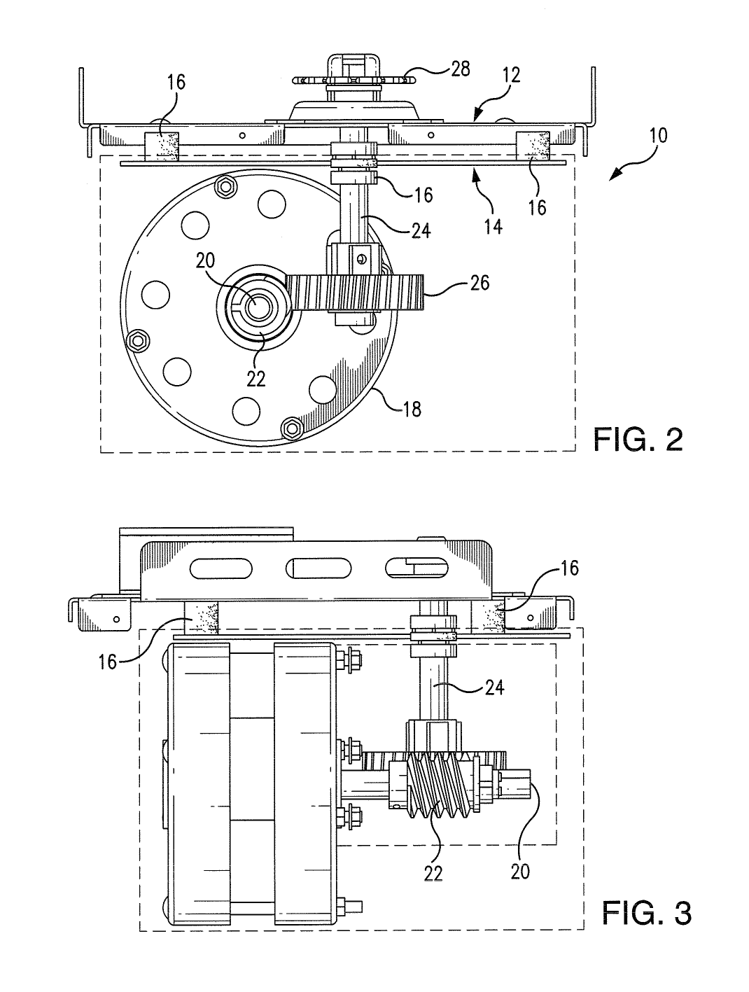

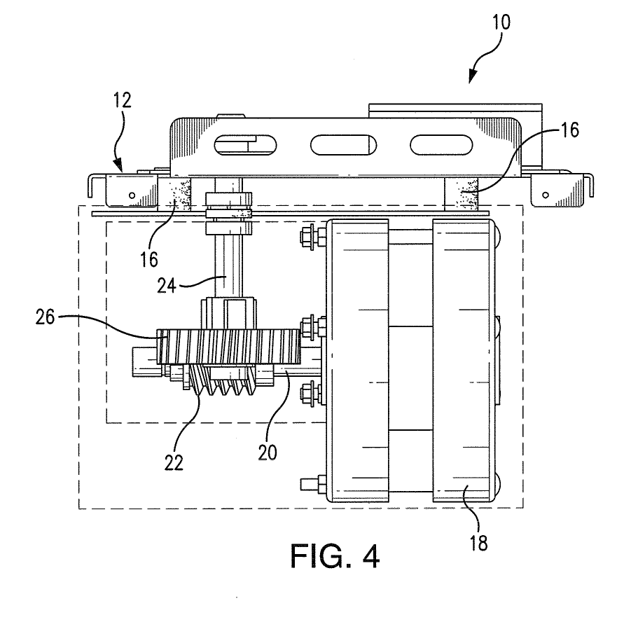

With reference to FIGS. 2-4, the present invention according to the illustrated embodiment relates to a motor mount assembly preferably for use with an automatic door operator, designated generally by reference numeral 10. It is to be appreciated that while the motor mount assembly as shown in FIGS. 2-4 is configured to be integrated with a door operating system (e.g., such as a garage door operating system), it is not to be understood as to be limited to use with such a door operating systems but rather may be applied to any system requiring a similarly configured motor mount assembly 10.

Assembly 10 preferably includes a primary chassis 12 coupled to a secondary chassis 14 using coupling elements 16 having vibration dampening qualities, such as rubber couplers. Primary assembly 14 may be coupled to portion of a building structure (e.g., a building/house ceiling). As to be discussed further below, vibration originating from a component of the secondary chassis 14 (e.g., a motor) are thus dampened by coupling elements 16 and hence are not transmitted to the primary chassis 12, or are significantly reduced therefrom.

As shown in the illustrated embodiment of FIGS. 2-4, secondary chassis 14 is shown to include a motor 18 preferably operably connected to a portion of the secondary chassis 14. Extending from motor 18 is an elongate motor shaft 20 having a worm gear 22 connected to a portion of elongate motor shaft 20. Rotatably extending through both the primary chassis 12 and secondary chassis 14 is an elongate drive shaft 24 having opposing first and second ends. A drive gear 26 is coupled to a first end of drive shaft 24 and is in geared engagement with the worm gear 22 such that rotation of the elongate motor shaft 20 (via motor 18) causes corresponding rotation of drive shaft 24, via worm gear 22 and drive gear 26.

The second end portion of elongate drive shaft 24 is shown coupled to a drive sprocket 28. Preferably, drive sprocket 28 is configured to engage a portion of a drive assembly for a door operating system (not shown) for causing a door to move preferably between open and closed positions. The motor 18 is preferably under the control of a control unit provided in the aforesaid door operating assembly.

It is to be appreciated and understood that an advantage of the present invention is any vibrations caused by motor 18 in the secondary chassis 14 are either obviated or significantly reduced from being transferred to the primary chassis 12, which is advantageous in that the primary chassis 12 my be attached to a ceiling portion of a house or similar structure in which vibrations are distributive and unwanted.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A motor mounting assembly comprising:
a primary chassis having a drive gear assembly configured and coupled to a movable barrier operable for causing movement of the movable barrier between first and second positions; and
a secondary chassis isolated from the primary chassis configured to mount to a motor assembly operable to actuate the drive gear assembly so as to cause movement of the movable barrier between the first and second positions.

2. A motor mounting assembly as recited in claim 1 further including at least one rubber damper for isolating the primary chassis from the secondary chassis.

3. A motor mounting assembly as recited in claim 2 wherein the drive gear assembly includes:
a worm gear coupled to the motor assembly; and
a drive assembly coupled to the worm gear, the drive assembly including:
a drive gear coupled to the worm gear; and
a drive shaft coupled to the worm gear.

4. A motor mounting assembly as recited in claim 3 wherein the drive shaft rotatably extends through the primary chassis.

5. A motor mounting assembly as recited in claim 4 wherein the drive shaft assembly further includes a drive sprocket operably coupled to the movable barrier to cause movement of the movable barrier the first and second positions.

6. A motor mounting assembly as recited in claim 5 wherein the movable barrier is a door.

7. A motor mounting assembly as recited in claim 6 wherein the door is a garage door.

8. A door operating system for open and closing a door, the door operating system comprising:
a control unit for providing a signal indicative of whether the door is to be moved to an open or closed position;
a motor mounting assembly coupled to the control unit, the motor mounting assembly including:
a motor operatively coupled to the control unit;
a primary chassis having a drive gear assembly coupled to the door and the motor, the drive gear assembly configured and operable for causing movement of the door between first and second positions; and
a secondary chassis isolated from the primary chassis configured to mount to the motor assembly.

9. A door operating system for open and closing a door as recited in claim 8 further including at least one rubber damper for isolating the primary chassis from the secondary chassis.

10. A door operating system for open and closing a door as recited in claim 9 wherein the drive gear assembly includes:
a worm gear coupled to the motor assembly; and
a drive assembly coupled to the worm gear, the drive assembly including:
a drive gear coupled to the worm gear; and
a drive shaft coupled to the worm gear.

11. A door operating system for open and closing a door as recited in claim 10 wherein the drive shaft rotatably extends through the primary chassis.

12. A door operating system for open and closing a door as recited in claim 11 wherein the drive assembly further includes a drive sprocket operably coupled to the movable barrier to cause movement of the movable barrier the first and second positions.

13. A door operating system for open and closing a door as recited in claim 12 wherein the door is a garage door.

14. A door operating system for open and closing a door as recited in claim 8 wherein the motor mounting assembly is mounted beneath the door.

15. A garage door operating system for open and closing a garage door, the garage door operating system comprising:
a control unit for providing a signal indicative of whether the garage door is to be moved to an open or closed position;
a motor mounting assembly coupled to the control unit, the motor mounting assembly including:
a motor operatively coupled to the control unit;
a primary chassis having a drive gear assembly coupled to the door and the motor, the drive gear assembly configured and operable for causing movement of the garage door between first and second positions;
a secondary chassis isolated from the primary chassis configured to mount to the motor assembly; and
at least one rubber damper for isolating the primary chassis from the secondary chassis.

16. A garage door operating as recited in claim 15 wherein the drive gear assembly includes:
a worm gear coupled to the motor assembly; and
a drive assembly coupled to the worm gear, the drive assembly including:
a drive gear coupled to the worm gear; and
a drive shaft coupled to the worm gear.

17. A garage door operating as recited in claim 16 wherein the motor mounting assembly is mounted beneath the door.
